(19) United States
(12) Patent Application Publication
(10) Pub. No.: US 2008/0056778 A1
(43) Pub. Date: Mar. 6, 2008

(54) BELT-ROTATING MECHANISM, AND IMAGE FORMING APPARATUS

(76) Inventors: Satoru Tao, Ibaraki (JP); Yoshihiko Sano, Ibaraki (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/839,841

(22) Filed: Aug. 16, 2007

(30) Foreign Application Priority Data
Aug. 30, 2006 (JP) 2006-232899

(51) Int. Cl. G03G 15/01

(52) U.S. Cl. 399/302; 399/303

(57) ABSTRACT

An image forming apparatus includes a belt-rotating unit, a meandering-correction unit, and an attach-detach control unit. The belt-rotating unit rotates an endless belt. The meandering-correction unit corrects meandering of the belt. The attach-detach control unit relatively moves the belt and an abutting member such that a surface of the belt abuts against or detaches from the abutting member. The surface of the belt is abutted against the abutting member before the belt attains a constant rotating speed.

### CROSS-REFERENCE TO RELATED APPLICATIONS

The present application claims priority to and incorporates by reference the entire contents of Japanese priority document, 2006-232899 filed in Japan on Aug. 30, 2006.

### BACKGROUND OF THE INVENTION

1. Field of the Invention

The present invention generally relates to an image forming apparatus and specifically relates to a belt rotating mechanism that rotates an endless belt.

2. Description of the Related Art

Tandem-type image forming apparatuses, such as printers and copying machines are known in the art. In a tandem-type image forming apparatus, multiple photosensitive drums are arranged along the direction of movement of an intermediate transfer belt, which is an endless belt. An electrostatic latent image is formed on each of the photosensitive drums. The electrostatic latent image on each of the photosensitive drum is then developed with a single-color toner, such as yellow, cyan, magenta, and black, into a single-color toner image. The toner images are then sequentially transferred onto the intermediate transfer belt, while rotating the intermediate transfer belt, by using a primary transfer unit and are superimposed on one another to form a toner image in full color. The toner image in full color is then transferred onto a sheet of paper by using a secondary transfer unit. The intermediate transfer belt is rotated by using a belt-rotating mechanism. While rotating, sometimes the intermediate transfer belt slants or meanders in the direction along its width, i.e., in the direction orthogonal to its rotating direction. If the intermediate transfer belt happens to be meandering at the time when the toner images are being transferred onto it, the toner images do not superimpose accurately on each other thereby badly affecting the quality of the color image. Thus, there is a need of a mechanism that can correct meandering of the intermediate transfer belt.

Various methods are being used to correct meandering of the intermediate transfer belt. In one method, the edges of the intermediate transfer belt are guide between guides so that the intermediate transfer belt does not meander.

Another method is to specify one of the rollers used to support the intermediate transfer belt as a steering roller and control the tilt angle of the steering roller with respect to the base level (hereinafter, “steering method”). An application of the steering method is disclosed in Japanese Patent Application Laid-Open No. 2002-287527 in which the tilt of an alignment roller is controlled proportional to the position of an intermediate transfer belt. The steering method is a better option than guiding the edges of the intermediate transfer belt. That is because implementing the steering method saves the intermediate transfer belt from over-burdening thereby enhancing its durability.

In an image forming apparatus that includes an attach-detach device used for primary transfer, an intermediate transfer belt is abutted against photosensitive drums at the start of image formation, while the intermediate transfer belt is detached from the photosensitive drums after completion of the image formation. In an image forming apparatus that includes an attach-detach device for secondary transfer, an intermediate transfer belt is abutted against a secondary transfer unit at the start of image formation, while the intermediate transfer belt is detached from the secondary transfer unit after completion of the image formation.

Usually, the intermediate transfer belt vibrates when it is abutted against or detached from the photosensitive drums or the secondary transfer unit. The vibrations cause unevenness in color density or misalignment in the color image in the direction along the width of the intermediate transfer belt. To avoid such problems, a method is disclosed in Japanese Patent Application Laid-Open No. 2003-57915 in which the intermediate transfer belt is not detached from the photosensitive drums until all the toner images formed on the photosensitive drums are transferred onto a sheet of paper.

As described above, in a conventional image forming apparatus disclosed in Japanese Patent Application Laid-Open No. 2002-287527, meandering of an intermediate transfer belt is corrected by adjusting the tilt angle of the steering roller and retaining a uniform tension in the direction along the width of the intermediate transfer belt. It is necessary to control meandering of the intermediate transfer belt to form a high quality color image. Meandering of the intermediate transfer belt occurs corresponding to the variation in the rotating position of the intermediate transfer belt. Hence, to control the meandering, it is actually necessary to curb the rotating speed at which the intermediate transfer belt is allowed to meander (hereinafter, “meandering speed”). However, any sudden addition of an uneven tension in the direction along the width of the intermediate transfer belt that is under stable rotation causes variation in the rotating position of the intermediate transfer belt. As a result, there is a high possibility that the meandering speed of the intermediate transfer belt exceeds the allowed range during a period required for the intermediate transfer belt to resume stable rotation.

In a conventional image forming apparatus disclosed in Japanese Patent Application Laid-Open No. 2003-57915, the problem of unevenness in color density or misalignment occurring in the color image is solved by adjusting the timing of the toner image formation and the detaching process performed by the attach-detach mechanism. However, relation between the rotation of the intermediate transfer belt and attaching-detaching process performed by the attach-detach mechanism is not taken into consideration. That relation is a very important factor in a belt-rotating mechanism implementing the steering method. The abutting and detaching process performed by the attach-detach mechanism causes variation in tension in the direction along the width of the intermediate transfer belt. The reason for that is when the attach-detach unit for primary transfer lifts or lowers the intermediate transfer belt for abutting or detaching, the tension in the direction along the width of the intermediate transfer belt that develops on each roller supporting the intermediate transfer belt varies. Furthermore, nip pressure in the direction along the width of the intermediate transfer belt also varies depending on whether the intermediate transfer belt is abutted against or detached from the photosensitive drums and the secondary transfer unit.

As a result, during image formation, if the photosensitive drums and the secondary transfer unit are abutted against or detached from the rotating intermediate transfer belt, there is a high possibility that the meandering speed of the intermediate transfer belt exceeds the allowed range because of the variation in tension in the direction along its width. A certain amount of time is required to curb the meandering speed of the intermediate transfer belt and unless the meandering speed of the intermediate transfer belt is curbed, the image forming apparatus cannot resume image printing. That is, the more the time it takes to curb the meandering speed of the intermediate transfer belt, the more the image forming apparatus has to wait to resume image printing thereby badly affecting the image printing efficiency of the image forming apparatus.

Hence, to control the meandering speed, it is recommended to rotate the intermediate transfer belt only when it is abutted against the photosensitive drums and the secondary transfer unit. In other words, when starting or stopping the rotation of the intermediate transfer belt, it is necessary to consider whether the photosensitive drums and the secondary transfer unit are in the abutted state or the detached state, so that the period for which the intermediate transfer belt rotates without being abutted against the photosensitive drums and the secondary transfer unit can be minimized.

A technology is disclosed in Japanese Patent Application Laid-Open No. 2005-266269 that prevents any damage to the surface of an intermediate transfer belt caused by a friction between the intermediate transfer belt and photosensitive drums. In that technology, the intermediate transfer belt is abutted against the photosensitive drums only when rotation of the intermediate transfer belt attains a constant speed (final speed).

However, in a belt-rotating mechanism, which corrects meandering of the intermediate transfer belt, disclosed in Japanese Patent Application Laid-Open No. 2005-266269, if the intermediate transfer belt is rotated without being abutted against the photosensitive drums or a secondary transfer unit, the meandering speed of the intermediate transfer belt may exceed the allowed range and it takes long time to curb the meandering speed.

### SUMMARY OF THE INVENTION

It is an object of the present invention to at least partially solve the problems in the conventional technology.

According to an aspect of the present invention, there is provided a belt-rotating mechanism for rotating an endless belt. The belt-rotating mechanism includes a belt-rotating unit that is configured to rotate the belt; a sensing unit that senses meandering of the belt; a meandering-correction unit that corrects meandering of the belt when the sensing unit senses meandering of the belt; and an attach-detach unit that relatively moves the belt and an abutting member such that a surface of the belt abuts against or detaches from the abutting member, wherein the attach-detach unit relatively moves the belt and an abutting member such that the surface of the belt abuts against the abutting member before the belt attains a constant rotating speed.

According to another aspect of the present invention, there is provided a belt-rotating mechanism for rotating an endless belt. The belt-rotating mechanism includes a belt-rotating unit that is configured to rotate the belt; a sensing unit that senses meandering of the belt; a meandering-correction unit that corrects meandering of the belt when the sensing unit senses meandering of the belt; and an attach-detach unit that relatively moves the belt and an abutting member such that a surface of the belt abuts against or detaches from the abutting member, wherein the attach-detach unit relatively moves the belt and an abutting member such that the surface of the belt is detached from the abutting member after a rotating speed of the belt starts declining from a constant rotating speed.

According to still another aspect of the present invention, there is provided an image forming apparatus that includes the above belt-rotating mechanism.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus according to a first embodiment of the present invention with primary transfer units and a secondary transfer unit in a state abutted against an intermediate transfer belt;

FIG. 2 is a schematic diagram of the image forming apparatus with the primary transfer units and the secondary transfer unit in a state detached from the intermediate transfer belt;

FIG. 3 is a perspective view of a belt-rotating mechanism shown in FIG. 1;

FIG. 4 is an enlarged side view of a meandering-correction mechanism shown in FIG. 3;

FIG. 5 is a perspective view of a belt-position detecting mechanism shown in FIG. 3;

FIG. 6 is a graph depicting the characteristics of a displacement sensor shown in FIG. 5;

FIG. 7 is a block diagram of a control unit for use in the image forming apparatus shown in FIG. 1; and

FIG. 8 is a diagram for explaining the sequence of operations performed at the start and at the completion of the image forming process in the image forming apparatus shown in FIG. 1.

### DETAILED DESCRIPTION OF THE PREFERRED EMBODIMENTS

Exemplary embodiments of the present invention are described in detail below with reference to the accompanying drawings.

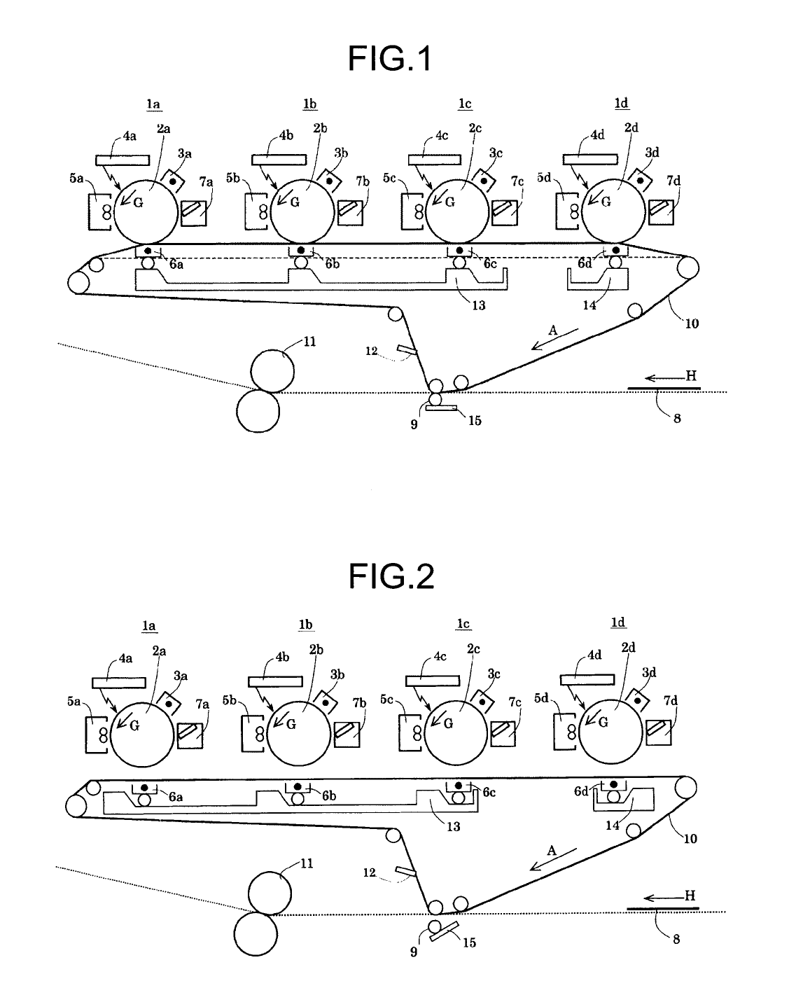

Description of an image forming apparatus that includes a belt-rotating mechanism and an attach-detach mechanism for transfer units is given below. FIG. 1 is a schematic diagram of a four-color image forming apparatus as an example of an image forming apparatus. The image forming apparatus includes four toner-image forming units 1a to ld that are arranged in a line along the direction of movement of an intermediate transfer belt 10.

The toner-image forming unit 1a includes a photosensitive drum 2a, a drum charger 3a, a light exposing unit 4a, a toner-image developer 5a, a primary transfer unit 6a, and a drum-cleaning unit 7a. The remaining toner-image forming units 1b to 1d also have an identical structure to that of the toner-image forming unit 1a. The description of the toner-image forming units 1b to 1d is omitted to avoid redundant explanation. Components in the toner-image forming units 1b to 1d identical to those in the toner-image forming unit 1a have same reference numerals except corresponding letters ‘b’, ‘c’, and ‘d’ replacing the letter ‘a’.

Each of the toner-image forming units 1a, 1b, 1c, and 1d forms a toner image in a single color of yellow, magenta, cyan, and black. When the toner-image forming unit 1a receives an instruction from a controller (not shown) to start an image forming process, the photosensitive drum 2a starts rotating in the direction shown by an arrow mark ‘G’ (anticlockwise direction). When the photosensitive drum 2a starts rotating, a high voltage is applied to the drum charger 3a that in turn electrically charges the surface of the photosensitive drum 2a in a uniform manner with a negative voltage.

The controller then sends, in the form of ON/OFF signals from the light exposing unit 4a, character data or graphic data converted in a dot image to the toner-image forming unit 1a. After the toner-image forming unit 1a receives the dot image, the surface of the photosensitive drum 2a is selectively exposed to light based on the dot image by using laser beams emitted from the light exposing unit 4a. As a result, the voltage at portions exposed to light decreases thereby forming an electrostatic latent image. When the electrostatic latent image on the photosensitive drum 2a reaches a position facing the toner-image developer 5a, the toner-image developer 5a blows a negatively charged yellow toner onto the electrostatic latent image so that the electrostatic latent image is converted into a yellow toner image.

The yellow toner image formed on the photosensitive drum 2a reaches the primary transfer unit 6a. The intermediate transfer belt 10, which rotates in the direction shown by an arrow mark ‘A’ (clockwise direction), is sandwiched between the photosensitive drum 2a and the primary transfer unit 6a. The primary transfer unit 6a is at a voltage higher than that of the photosensitive drum 2a because of which the yellow toner image is transferred onto the intermediate transfer belt 10, which is sandwiched between the photosensitive drum 2a and the primary transfer unit 6a. After the yellow toner image is transferred onto the intermediate transfer belt 10, the drum-cleaning unit 7a scrapes out any residual toner from the surface of the photosensitive drum 2a. Thus, the photosensitive drum 2a is kept ready to receive next dot-image data and repeat the image forming process for the next dot-image data.

In the same manner as the toner-image forming unit 1a forms a yellow toner image on the photosensitive drum 2a, the toner-image forming unit 1b forms a magenta toner image on the photosensitive drum 2b. Because of the action of the primary transfer unit 6b the magenta toner image is transferred onto the intermediate transfer belt 10. The timing of transferring the magenta toner image onto the intermediate transfer belt 10 is adjusted to match with the timing at which the yellow toner image, which is present on the photosensitive drum 2a, reaches the primary transfer unit 6b. The timing is so adjusted that the yellow toner image and the magenta toner image are superimposed onto each other over the intermediate transfer belt 10.

In the same manner, the toner-image forming unit 1c forms a cyan toner image on the photosensitive drum 2c, and the toner-image forming unit 1d forms a black toner image on the photosensitive drum 2d. The cyan toner image and the black toner image are also superimposed onto the image present on the intermediate transfer belt 10 thereby forming a full-color toner image in.

The full-color toner image then reaches a secondary transfer unit 9 as the intermediate transfer belt 10 rotates. At the same time, a recording paper 8 that is conveyed from a paper feeding unit (not shown) in the direction shown by an arrow mark ‘H’ also reaches the secondary transfer unit 9. The recording paper 8 is sandwiched between the intermediate transfer belt 10 and the secondary transfer unit 9. The secondary transfer unit 9 is at a voltage higher than that of the intermediate transfer belt 10 because of which the full-color toner image is transferred onto the recording paper 8, which is sandwiched between the intermediate transfer belt 10 and the secondary transfer unit 9. The recording paper 8 with the full-color toner image is then conveyed to a fixing unit 11 where the full-color toner image is fixed on the recording paper 8 by using heat and/or pressure. After the toner image in full color is transferred onto the recording paper 8, a belt-cleaning unit 12 scrapes out any residual toner on the intermediate transfer belt 10.

Given below is the description of the attach-detach mechanism for transfer units. The attach-detach mechanism includes a first attach-detach device 13, a second attach-detach device 14, and a third attach-detach device 15. The first attach-detach device 13 lifts the primary transfer units 6a to 6c, which are used for primary-transferring the toner images in yellow, cyan, and magenta, respectively, so that the intermediate transfer belt 10 is abutted against the photosensitive drums 2a to 2c. On the other hand, the first attach-detach device 13 lowers the primary transfer units 6a to 6c so that the intermediate transfer belt 10 is detached from the photosensitive drums 2a to 2c.

As shown in FIG. 1, the intermediate transfer belt 10 and the photosensitive drums 2a to 2c are retained in the abutted state while the image forming process is performed, while as shown in FIG. 2, the intermediate transfer belt 10 is detached from the photosensitive drums 2a to 2c after the image forming process is complete. That is, before starting the image forming process, the first attach-detach device 13 makes the intermediate transfer belt 10 abut against the photosensitive drums 2a to 2c, and after the completion of the image forming process, the first attach-detach device 13 detaches the intermediate transfer belt 10 from the photosensitive drums 2a to 2c. The first attach-detach device 13 is driven by a first attach-detach motor (not shown).

Similarly, the second attach-detach device 14 lifts the primary transfer unit 6d, which is used for primary-transferring the black toner image, so that the intermediate transfer belt 10 is abutted against the photosensitive drum 2d, and lowers the primary transfer unit 6d so that the intermediate transfer belt 10 is detached from the photosensitive drum 2d. The third attach-detach device 15 lifts the secondary transfer unit 9, which is used for secondary-transferring the toner image in full color, so that the intermediate transfer belt 10 is abutted against the secondary transfer unit 9, and lowers the secondary transfer unit 9 so that the secondary transfer unit 9 is detached from the intermediate transfer belt 10. Similar to the first attach-detach device 13, the second attach-detach device 14 and the third attach-detach device 15 make the intermediate transfer belt 10 abut against the photosensitive drum 2d and the secondary transfer unit 9, respectively, before starting the image forming process, while detach the intermediate transfer belt 10 from the photosensitive drum 2d and the secondary transfer unit 9, respectively, after completing the image forming process.

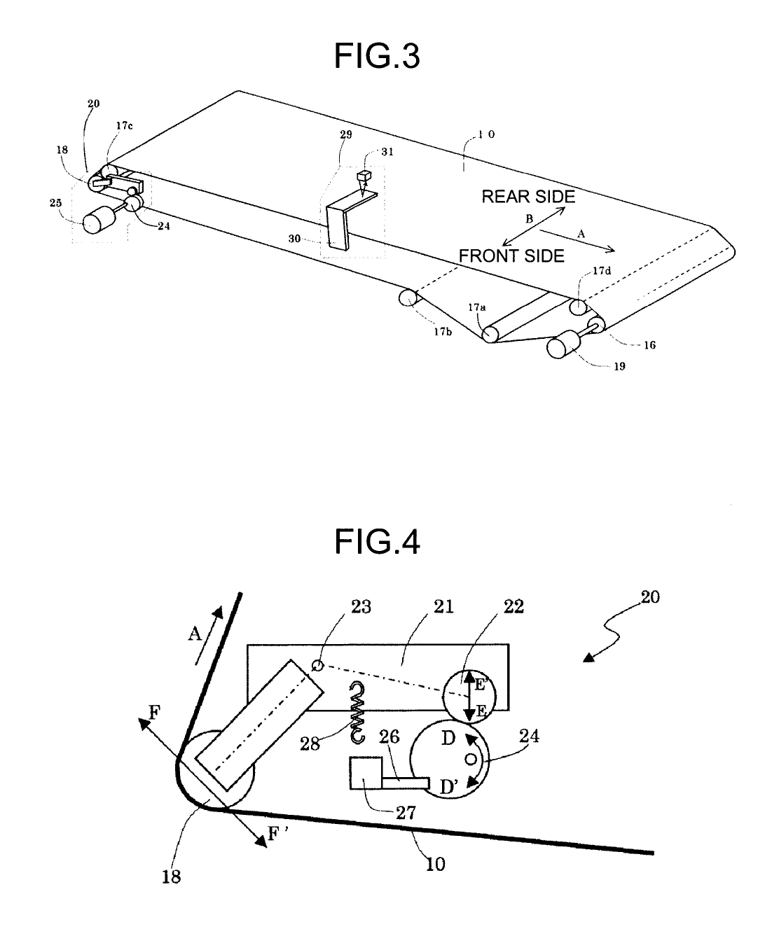

Given below is the description of the belt-rotating mechanism. FIG. 3 is a perspective view of the belt-rotating mechanism that rotates the intermediate transfer belt 10. In FIG. 3, an arrow mark ‘A’ indicates the direction (clockwise direction) in which the intermediate transfer belt 10 rotates, while a two-sided arrow mark ‘B’ indicates the direction along the width of the intermediate transfer belt 10. The side of the intermediate transfer belt 10 on which a meandering-correction mechanism 20 is provided as shown in FIG. 3 is considered to be the front side, while the other side is considered to be the rear side.

The belt-rotating mechanism includes a driving roller 16, four driven rollers 17a to 17d, a steering roller 18, and a belt-rotating motor 19. The intermediate transfer belt 10 is stretched around the driving roller 16, the driven rollers 17a to 17d, and the steering roller 18. The driving roller 16 is coupled with the belt-rotating motor 19. The belt-rotating motor 19 rotates the driving roller 16 that in turn rotates the intermediate transfer belt 10 in the clockwise direction.

Sometimes the four toner images for yellow, magenta, cyan, and black that are formed by the toner-image forming units 1a, 1b, 1c, and 1d, respectively, are misaligned with respect to each other in the direction along the width of the intermediate transfer belt 10. The degree of relative misalignment is maximum in case of the toner images formed in the toner-image forming unit 1a and the toner-image forming unit 1d, which are arranged farthest from each other. It is recommended to curb the relative misalignment of two toner images within 48 micrometers in the direction along the width of the intermediate transfer belt 10.

There are various factors that cause the misalignment of the toner images on the intermediate transfer belt 10. One of them is meandering of the intermediate transfer belt 10. To minimize the misalignment of the toner images, it is necessary to curb the misaligning within 33 micrometers in the direction along the width of the intermediate transfer belt 10 when the intermediate transfer belt 10 reaches each of the toner-image forming units 1a to 1d. To achieve that, it is necessary to constantly curb the meandering speed of the rotating intermediate transfer belt 10 within the allowed range. The allowed range for the meandering speed for the intermediate transfer belt 10 is, for example, ±19.5 μm/s.

To correct over-meandering of the intermediate transfer belt 10, as shown in FIG. 4, the meandering-correction mechanism 20 is provided along with the belt-rotating mechanism. The meandering-correction mechanism 20 includes a swinging arm 21 that is pivotable around a swinging-arm shaft 23. One end of the swinging arm 21 is coupled with a side surface of the steering roller 18, while a bearing 22 is fixed at the other end of the swinging arm 21. The steering roller 18, around which the intermediate transfer belt 10 is stretched, is immovably fixed. The meandering-correction mechanism 20 also includes an off-center cam 24 that pivots around a shaft not located at the center of the off-center cam 24. A shaft of a steering motor 25 (see FIG. 3) is coupled with the shaft of the off-center cam 24. A screening plate 26 is coupled to the off-center cam 24. An off-center cam detecting unit 27 detects the current position of the off-center cam 24 based on screening plate 26. The off-center cam 24 constantly abuts against the bearing 22 because of the tension developed by a swinging-arm spring 28 that is attached to the swinging arm 21.

When the off-center cam 24 pivots in the direction shown by letter D in FIG. 4, the bearing 22 shifts in the direction shown by letter E thereby making the swinging arm 21 pivot around the swinging-arm shaft 23. When the swinging arm 21 pivots around the swinging-arm shaft 23, the side surface of the steering roller 18, which is coupled with the swinging arm 21, tilts in the direction shown by letter F in FIG. 4.

When the side surface of the steering roller 18 tilts in the direction shown by letter F, the tension at the front side of the intermediate transfer belt 10 becomes larger as compared to the tension at the rear side. As a result, the intermediate transfer belt 10 meanders towards the rear side at a meandering speed that depends on the tilt angle of the steering roller 18, which is formed when the steering roller 18 tilts in the direction shown by letter F. On the other hand, when the off-center cam 24 pivots in the direction shown by letter D′ in FIG. 4, the bearing 22 shifts in the direction shown by letter E′ and accordingly the side surface of the steering roller 18 tilts in the direction shown by letter F′ in FIG. 4.

When the side surface of the steering roller 18 tilts in the direction shown by letter F′, the tension at the rear side of the intermediate transfer belt 10 increases as compared to that at the front side. As a result, the intermediate transfer belt 10 meanders towards the front side at a meandering speed that depends on the tilt angle of the steering roller 18, which is formed when the steering roller 18 tilts in the direction shown by letter F′.

In this manner, when the intermediate transfer belt 10 meanders towards the front side, the steering roller 18 is made to tilt at such an angle that the intermediate transfer belt shifts back towards the rear side. On the other hand, when the intermediate transfer belt 10 meanders towards the rear side, the steering roller 18 is made to tilt at such an angle that the intermediate transfer belt shifts back towards the front side. Thus, meandering of the intermediate transfer belt 10 is controlled by adjusting the tilt movement and the tilt angle of the steering roller 18 thereby curbing the meandering speed of the intermediate transfer belt 10 within the allowed range.

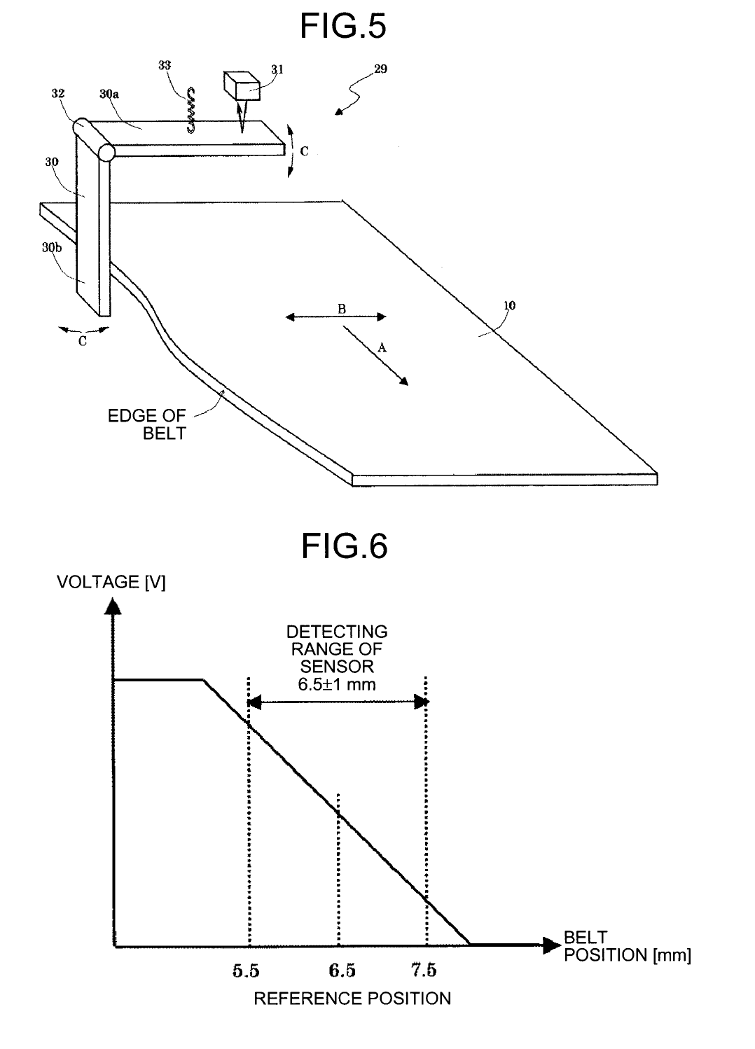

Given below is a description with reference to FIG. 5 of a belt-position detecting mechanism 29 that detects the widthwise meandering of the intermediate transfer belt 10. The belt-position detecting unit includes an L-shaped contact member 30 and a displacement sensor 31. The contact member 30 includes a first contact plate 30a and a second contact plate 30b, and it is pivotably supported by a contact-member shaft 32. Specifically, the contact member 30 is pivotable in the direction shown by two-sided arrow marks ‘ C’. A contact-member spring 33 is attached to the first contact plate 30a. Because of the action of the contact-member spring 33, the second contact plate 30b is forced to constantly abut against the edge on the front side of the intermediate transfer belt 10.

The displacement sensor 31 is arranged near between a center and an end of the first contact plate 30a. The displacement sensor 31 includes a light emitting unit (not shown) and a light receiving unit (not shown). The light emitted by the light emitting unit is reflected by the first contact plate 30a. The light receiving unit receives the reflected light. The displacement sensor 31 detects the distance up to the first contact plate 30a by comparing the position of the reflected light with a reference position.

The displacement sensor 31 is arranged at a predetermined distance, e.g. 6.5 millimeters, from the first contact plate 30a. The distance between the displacement sensor 31 and the first contact plate 30a varies when the contact member 30 pivots upon the contact-member shaft 32. The displacement sensor 31 outputs an electrical signal indicative of the distance between the displacement sensor 31 and the first contact plate 30a. FIG. 6 is a graph depicting the characteristics of the displacement sensor 31. The horizontal axis depicts the belt position (millimeters), while the vertical axis depicts the output voltage (volts). The detecting range of the displacement sensor 31 is 6.1 millimeters±1 millimeter, i.e., from 5 millimeters to 7.5 millimeters and the detecting precision is ±10 micrometers.

The belt-rotating mechanism implements a steering method to control meandering of the intermediate transfer belt 10. More particularly, meandering of the intermediate transfer belt 10 is controlled by adjusting the tilt angle of the steering roller 18 thereby retaining a uniform tension in the direction along the width of the intermediate transfer belt 10. To control meandering of the intermediate transfer belt 10, implementing the steering method is a better option than guiding the edges of the intermediate transfer belt 10. That is because implementing the steering method saves the intermediate transfer belt 10 from over-burdening thereby enhancing its durability. However, any sudden addition of an uneven tension in the direction along the width of the intermediate transfer belt 10 that is under rotation still results in meandering of the intermediate transfer belt 10. In that case, the meandering speed may exceed the allowed range during a period required for the intermediate transfer belt 10 to resume stable rotation.

Moreover, in the attach-detach mechanism, the process of abutting or detaching produces jolts of varying degrees depending on each attach-detach device, which may result in sudden addition of an uneven tension in the direction along the width of the intermediate transfer belt 10 that is under rotation. More particularly, when the first attach-detach device 13 and the second attach-detach device 14 lift the intermediate transfer belt 10, the tension in the direction along the width of the intermediate transfer belt 10 that develops on each roller supporting it varies. Furthermore, nip pressure in the direction along the width of the intermediate transfer belt 10 also varies depending on whether the intermediate transfer belt 10 is abutted against or detached from the photosensitive drums 2a to 2d and the secondary transfer unit 9.

Thus, during the image forming process, if the photosensitive drums 2a to 2d and the secondary transfer unit 9 are abutted against or detached from the rotating intermediate transfer belt 10, there is a high possibility that the meandering speed of the intermediate transfer belt 10 exceeds the allowed range because of the variation in tension in the direction along its width. Hence, to control the meandering speed, it is recommended to rotate the intermediate transfer belt 10 only when it is abutted against the photosensitive drums 2a to 2d and the secondary transfer unit 9. In other words, when starting or stopping the rotation of the intermediate transfer belt 10, it is necessary to consider whether the photosensitive drums 2a to 2d and the secondary transfer unit 9 are in the abutted state or detached state, so that the period for which the intermediate transfer belt 10 rotates without being abutted against the photosensitive drums 2a to 2d and the secondary transfer unit 9 can be minimized.

It is obvious that a certain amount of time is required to curb the meandering speed of the intermediate transfer belt 10. Unless the meandering speed of the intermediate transfer belt 10 is curbed, the image forming apparatus cannot resume image printing. That is, the more the time it takes to curb the meandering speed of the intermediate transfer belt 10, the more the image forming apparatus has to wait to resume image printing thereby badly affecting the image printing efficiency of the image forming apparatus.

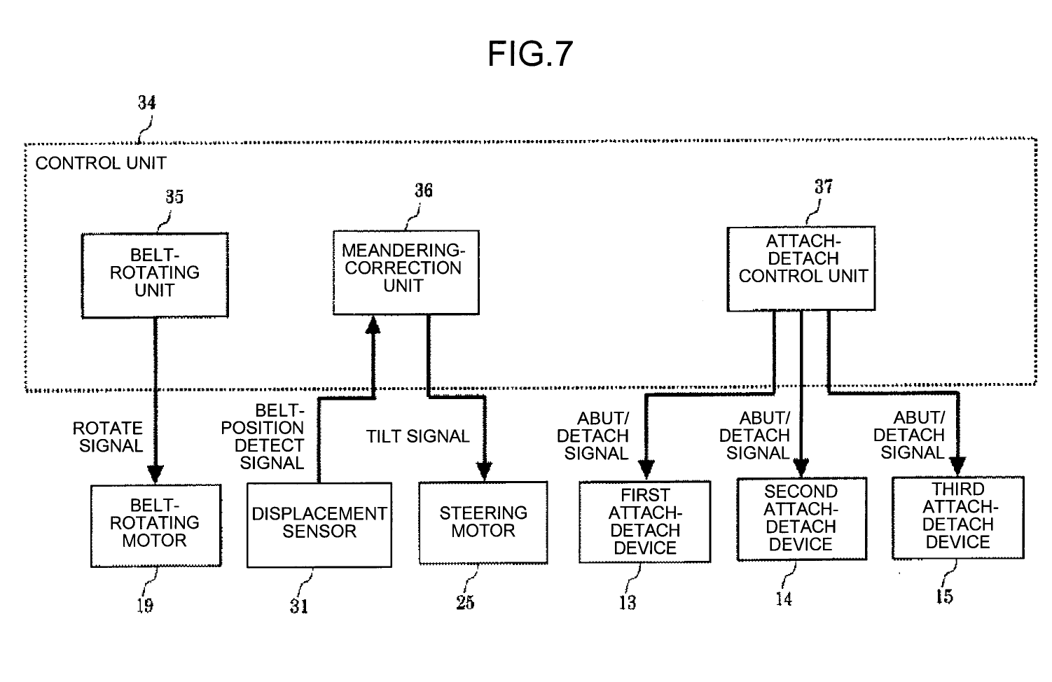

FIG. 7 is a block diagram of a control unit 34 for use in the image forming apparatus. The control unit 34 includes a belt-rotating unit 35, a meandering-correction unit 36, and an attach-detach control unit 37. The belt-rotating unit 35 sends a rotate signal to the belt-rotating motor 19 that in turn rotates the intermediate transfer belt 10. The meandering-correction unit 36 periodically sends a tilt signal to the steering motor 25 based on a belt-position detect signal received from the displacement sensor 31. The steering motor 25 then performs tilting of the steering roller 18 as per requirement. Any available method can be used to generate the rotate signal. For example, the rotate signal is generated based on proportional control or a proportional-integral control with respect to the position of the intermediate transfer belt 10.

At the start of an image forming process, the attach-detach control unit 37 sends an abut signal to the first attach-detach device 13 and the second attach-detach device 14. The first attach-detach device 13 then lifts the primary transfer units 6a to 6c, while the second attach-detach device 14 lifts the primary transfer unit 6d so that the intermediate transfer belt 10 is abutted against the photosensitive drums 2a to 2d as shown in FIG. 1. Similarly, the attach-detach control unit 37 sends an abut signal to the third attach-detach device 15 that in turn lifts the secondary transfer unit 9 so that the intermediate transfer belt 10 is abutted against the secondary transfer unit 9 as shown in FIG. 1. On the other hand, at the time of completing the image forming process, the attach-detach control unit 37 sends a detach signal to the first attach-detach device 13 and the second attach-detach device 14. The first attach-detach device 13 then lowers the primary transfer units 6a to 6c, while the second attach-detach device 14 lowers the primary transfer unit 6d so that the intermediate transfer belt 10 is detached from the photosensitive drums 2a to 2d as shown in FIG. 2. Similarly, the attach-detach control unit 37 sends a detach signal to the third attach-detach device 15 that in turn lowers the secondary transfer unit 9 so that the secondary transfer unit 9 is detached from the intermediate transfer belt 10 as shown in FIG. 2.

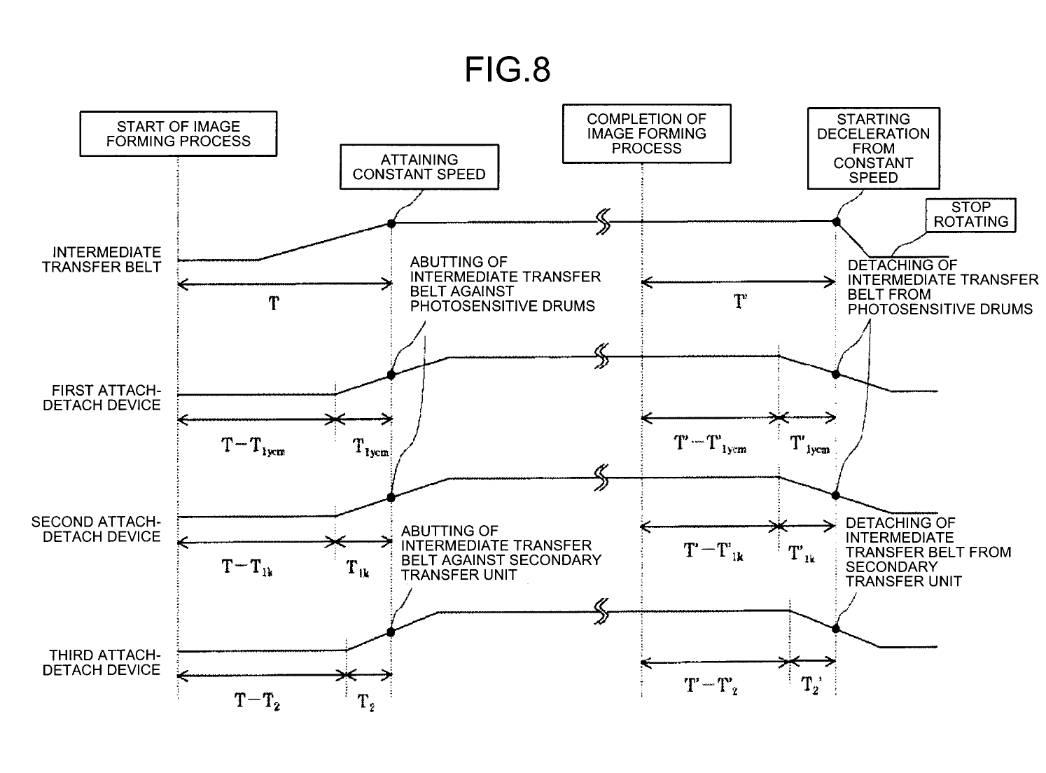

FIG. 8 is a diagram for explaining the sequence of operations performed at the start of an image forming process and at the completion of the image forming process in the image forming apparatus. At the start of an image forming process, the time required for the belt-rotating motor 19 to attain a constant speed (final speed) is considered to be T. The time T is adjusted such that the photosensitive drums 2a to 2d and the secondary transfer unit 9 also attain the same constant speed at the time T.

The time required for the first attach-detach device 13 to start abutting the intermediate transfer belt 10 against one of the photosensitive drums 2a to 2c is considered to be T_{1ycm}. To start the abutting process, the first attach-detach device 13 first has to lift the primary transfer units 6a to 6c and then abut them against the intermediate transfer belt 10. Thus, a small time lag occurs before the intermediate transfer belt 10 is actually abutted against one of the photosensitive drums 2a to 2c. That time lag can be used to set the time T_{1ycm} by using information about the positional relation between the intermediate transfer belt 10 and the photosensitive drums 2a to 2c. Similar to the first attach-detach device 13, the time required for the second attach-detach device 14 to start abutting the intermediate transfer belt 10 against the photosensitive drum 2d is considered to be T₁ₖ, while the time required for the third attach-detach device 15 to start abutting the secondary transfer unit 9 against the intermediate transfer belt 10 is considered to be “T₂”. For example, values for T, T_{1ycm}, T₁ₖ, and T₂ can be set as T=2395 milliseconds, T_{1ycm}=T₁ₖ=380 milliseconds, and T₂=275 milliseconds.

With respect to the time T at which the belt-rotating motor 19 attains the constant speed from the start of the image forming process, the attach-detach control unit 37 sends the abut signal to the first attach-detach device 13 at the time T-T_{1ycm}. Similarly, the attach-detach control unit 37 sends the abut signal to the second attach-detach device 14 at the time T-T₁ₖ and to the third attach-detach device 15 at the time T-T₂.

After completing the image forming process, the time required for the belt-rotating motor 19 to start decelerating from the constant speed is considered as T′. The time required for the first attach-detach device 13 to detach the intermediate transfer belt 10 from all the photosensitive drums 2a to 2c is considered to be T′_{1ycm}. Similar to the first attach-detach device 13, the time required for the second attach-detach device 14 to detach the intermediate transfer belt 10 from the photosensitive drum 2d is considered to be T′₁ₖ, while the time required for the third attach-detach device 15 to detach the secondary transfer unit 9 from the intermediate transfer belt 10 is considered to be T′₂.

With respect to the time T′ at which the belt-rotating motor 19 starts decelerating from the constant speed after completing the image forming process, the attach-detach control unit 37 sends the detach signal to the first attach-detach device 13 at the time T′-T′_{1ycm}. Similarly, the attach-detach control unit 37 sends the detach signal to the second attach-detach device 14 at the time T′-T′₁ₖ and to the third attach-detach device 15 at the time T′-T′₂.

Thus, in the sequence of operations shown in FIG. 8, the intermediate transfer belt 10 is rotated at a constant speed only when it is abutted against the photosensitive drums 2a to 2d and the secondary transfer unit 9. The period for which the intermediate transfer belt 10 rotates without being abutted against the photosensitive drums 2a to 2d and the secondary transfer unit 9 is also minimized. Usually, there is a possibility that the surface of an intermediate transfer belt and that of photosensitive drums are damaged because of the friction caused by the difference in their corresponding rotating speeds. However, as described above, because the intermediate transfer belt 10 and the photosensitive drums 2a to 2d rotate at the same constant speed, the problem of damaging the surfaces does not arise.

As described above, the adverse effect of variation in tension in the direction along the width of the intermediate transfer belt 10 that is under rotation is reduced and the meandering speed of the intermediate transfer belt 10 can be curbed to maximum extent. As a result, it is possible to provide the image forming apparatus that performs quick and high quality image printing.

The attach-detach mechanism is configured to lift or lower the primary transfer units 6a to 6d so that the intermediate transfer belt 10 is abutted against or detached from the photosensitive drums 2a to 2d. However, same results can be achieved by configuring an attach-detach mechanism that lifts or lowers the photosensitive drums 2a to 2d so that they are abutted against or detached from the intermediate transfer belt 10. As described above, toner images on the photosensitive drums 2a to 2c are primary-transferred onto the intermediate transfer belt 10 by using the corresponding primary transfer units 6a to 6d (i.e., image forming apparatus with intermediate transfer mechanism). However, an image forming apparatus can also be used in which a toner image on a photosensitive drum is directly transferred onto a recording paper that is conveyed on a conveyer belt (i.e., image forming apparatus with direct transfer mechanism).

The intermediate transfer belt 10 is abutted against the photosensitive drums 2a to 2d and the secondary transfer unit 9 just when the intermediate transfer belt 10 attains a constant rotating speed. On the other hand, the intermediate transfer belt 10 is detached from the photosensitive drums 2a to 2d and the secondary transfer unit 9 just when the rotating speed of the intermediate transfer belt 10 starts declining from the constant rotating speed. Such mechanism is implemented to enhance the durability of the intermediate transfer belt 10. However, if the durability of the intermediate transfer belt 10 is not an issue, then an attach-detach mechanism can be configured such that the intermediate transfer belt 10 is abutted against the photosensitive drums 2a to 2d and the secondary transfer unit 9 before the intermediate transfer belt 10 attains a constant rotating speed. Such mechanism helps in curbing the meandering speed better. On the other hand, the attach-detach mechanism can be configured such that the intermediate transfer belt 10 is detached from the photosensitive drums 2a to 2d and the secondary transfer unit 9 after the rotating speed of the intermediate transfer belt 10 starts declining from the constant rotating speed.

According to an embodiment of the present invention, because the outer surface of a belt is abutted against an abutting member before the belt attains a constant rotating speed, the meandering speed of the belt can be curbed to maximum extent and the time required to curb the meandering speed can also be reduced. Moreover, when such a belt-rotating mechanism is implemented in an image forming apparatus, the meandering speed of the belt at the start of an image forming process can be curbed to maximum extent thereby achieving quick and high quality image printing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A belt-rotating mechanism for rotating an endless belt, the belt-rotating mechanism comprising:
a belt-rotating unit that is configured to rotate the belt;
a sensing unit that senses meandering of the belt;
a meandering-correction unit that corrects meandering of the belt when the sensing unit senses meandering of the belt; and
an attach-detach unit that relatively moves the belt and an abutting member such that a surface of the belt abuts against or detaches from the abutting member, wherein the attach-detach unit relatively moves the belt and an abutting member such that the surface of the belt abuts against the abutting member before the belt attains a constant rotating speed.

2. The belt-rotating mechanism according to claim 1, wherein the attach-detach unit relatively moves the belt and the abutting member such that the surface of the belt abuts against the abutting member just when the belt attains the constant rotating speed.

3. The belt-rotating mechanism according to claim 1 is for use in an image forming apparatus, wherein the belt is a conveyer belt that conveys a recording paper, while the abutting member is an image carrying unit.

4. The belt-rotating mechanism according to claim 1 is for use in an image forming apparatus, wherein the belt is an intermediate transfer belt, while the abutting member is an image carrying unit.

5. The belt-rotating mechanism according to claim 1 is for use in an image forming apparatus, wherein the belt is an intermediate transfer belt, while the abutting member is a secondary transfer member.

6. An image forming apparatus comprising the belt-rotating mechanism according to claim 1.

7. A belt-rotating mechanism for rotating an endless belt, the belt-rotating mechanism comprising:
a belt-rotating unit that is configured to rotate the belt;
a sensing unit that senses meandering of the belt;
a meandering-correction unit that corrects meandering of the belt when the sensing unit senses meandering of the belt; and
an attach-detach unit that relatively moves the belt and an abutting member such that a surface of the belt abuts against or detaches from the abutting member, wherein the attach-detach unit relatively moves the belt and an abutting member such that the surface of the belt is detached from the abutting member after a rotating speed of the belt starts declining from a constant rotating speed.

8. The belt-rotating mechanism according to claim 7, wherein the attach-detach unit relatively moves the belt and the abutting member such that the surface of the belt is detached from the abutting member just when the rotating speed of the belt starts declining from a constant rotating speed.

9. The belt-rotating mechanism according to claim 7 is for use in an image forming apparatus, wherein the belt is a conveyer belt that conveys a recording paper, while the abutting member is an image carrying unit.

10. The belt-rotating mechanism according to claim 7 is for use in an image forming apparatus, wherein the belt is an intermediate transfer belt, while the abutting member is an image carrying unit.

11. The belt-rotating mechanism according to claim 7 is for use in an image forming apparatus, wherein the belt is an intermediate transfer belt, while the abutting member is a secondary transfer member.

12. An image forming apparatus comprising the belt-rotating mechanism according to claim 7.
